(19) United States
(12) Patent Application Publication
(10) Pub. No.: US 2012/0017254 A1
(43) Pub. Date: Jan. 19, 2012

(54) VIDEO COMMUNICATIONS SYSTEM

(75) Inventors: Duncan Barclay, London (GB); James F. Ohene-Djan, London (GB)

(73) Assignee: CORRESPONDENT CORP LTD, London (GB)

(21) Appl. No.: 13/123,405

(22) PCT Filed: Oct. 8, 2009
(86) PCT No.: PCT/GB09/51343

§ 371 Date: Aug. 29, 2011

(30) Foreign Application Priority Data
Oct. 8, 2008 (GB) 0818447.5

(51) Int. Cl. H04N 7/173

(52) U.S. Cl. 725/115

(57) ABSTRACT

A content server for use in a video content storage system for storing and distributing video content to system users, the server comprising: input means for communicating, across a communications network, with a system user at a remotely located terminal; a data store for storing video content; and output means for streaming stored video content across the communications network to a system user upon receipt of a request to viewed the stored content.

### FIELD OF INVENTION

This invention relates to improvements to a video communications system. Specifically, the present invention relates to a distributed communications system and associated communications tools and to the storage, management and exchange of digital video content. In particular, the present invention provides a system and method for the storage and accessing of digital video content by a plurality of users.

### BACKGROUND TO THE INVENTION

Video hosting websites such as youtube.com allow users to post and view videos over the Internet. However, such sites do not support the direct exchange of video messaging between users.

Known video conferencing systems generally require expensive equipment and software to be set up at either end of a proposed communications link and so are generally only used sparingly.

As a consequence of the above limitations with existing video conferencing and sharing systems user predominantly exchange communications either in the form of emails or via telephone conversations. Although these communication mechanisms have their own strengths it is often the case that contextual information is lost when communications are made via emails. Telephone conferencing allows individuals to easily engage in direct conversation but require all parties to be present at the same time.

It is therefore an object of the present invention to provide a communications system (and associated method and tools) to more efficiently structure and organise digital video content, to coordinate digital assets and resources and to provide a communications system that allows more efficient communication between contributors.

It is a further object of the present invention to provide a video messaging system that overcomes or substantially mitigates the limitations of the prior art.

It is a still further object of the present invention to provide a communications system which interacts with a remotely located user to update them of changes to the communication system.

### STATEMENTS OF INVENTION

According to a first aspect of the present invention there is provided a content server for use in a video content storage system for storing and distributing video content to system users, the server comprising: input means for communicating, across a communications network, with a system user at a remotely located terminal; a data store for storing video content; and output means for streaming stored video content across the communications network to a system user upon receipt of a request to viewed the stored content.

The present invention (which is also referred to herein as “Winkball™”) provides a video message system and associated two way video recorder that supports the exchange of video based messages (i.e. essentially video based emails) and also allows individuals to engage in real time two way video conferencing.

The first aspect of the present invention comprises a central server that hosts video content that is either created by users of the system or is uploaded to the system and streams this content to users as and when accessed.

System users may record and upload video via webcams associated with their computers and the uploaded video content is then stored on the central server.

Video messages and conversations created by the present invention may be shared with friends and family via a communications network linked via the central server. In a preferred embodiment the system allows only “white listed” individuals to exchange messages (i.e. messages can only be sent to users who appear in each others contacts book). The present invention therefore operates to a high degree of safety in terms of security and unsolicited video content.

The present invention may also comprise the following further features:
the ability to record two-way video conversations and save these as a single file on the communications network.
the ability to record two way conversations locally (i.e, on a single computer) or remotely (i.e, two computers on the internet).
the ability to send video content to a selected group off contacts via the communications network.
“Whitelist” video sharing ensuring only contacts registered with a user can send that user video content and ask a user to participate in video conversations.
the ability to post recorded video conversations to external websites and blogs.
the ability to import videos in the system from external sources.
the ability to export videos from the system to external destinations.

The content server may be conveniently be part of a distributed communications network that is accessible by a plurality of user computers. Further, the input means may be arranged to receive video content related data from system users and to receive new content for storage in the data store. The input means may also be arranged to receive instructions from system users to amend video content currently stored in the data store.

Video content stored in the data store may conveniently comprise a video content file and associated meta data. The meta data stored in the data store may conveniently be arranged to allow video content to be grouped by a content category or content author.

The output means may be arranged to stream a video content signal to system users to allow video content to be displayed on a graphical user interface of the user's user terminal. The server may also further comprise a messaging module arranged to allow users to send video messages, wherein the messaging module is arranged to insert meta data into outgoing messages. In such cases outgoing messages may have a sender address field and the messaging module may be arranged to insert meta data into the address field of each outgoing message.

Video content may be placed on a white list such that only authorised system users can access the video content.

The server may be arranged to embed stored video content as part of a video blog and the server may further be arranged to allow system users to post video content in reply to posts on the video blog.

The server may be arranged to group video content by author or by subject matter based on the meta-data stored in the data store

The server may be arranged to broadcast video content to one or more system users. In such a manner a broadcaster would be able to simultaneously send the same video content message (e.g. an advert) to multiple system users. The server may also be arranged to allow additional content files to be prepended or appended to video content exchanged between system users. In such instances the data store may comprise a plurality of additional content files such that each time a system user requests access to video content stored in the data store an additional content file is either prepended or appended to the streamed video content.

Two or more system users may, via the input means, record video content to the server as part of a video conference, the received video content from each user being stored in a single video content file on the server.

As video content stored on the server is changed the server may be arranged to output a notification signal to one or more system users. Conveniently, content may be classified by content category and following changes to video content associated with a particular content category, the server may be arranged to output a notification signal to system users who are associated with the particular content category.

Conveniently, the notification signal may be a push communication which may be sent to a notification icon on the remotely located terminal of a system user, the signal comprising instructions to control the behaviour of the icon. Preferably, the instructions sent to the notification icon are dependent on events occurring at the server.

In further embodiments, the server may be arranged to send different types of behaviour instructions to the notification icon depending on the events occurring at the server, each type of behaviour instruction causing the notification icon to behave in a different manner such that the icon may be controlled by the server to exhibit multiple behaviours. Conveniently, however, the server may be configurable by a system user to personalise the notification signals and associated behaviour instructions that are sent out by the server.

The events occurring on the server which result in the notification signal being sent may be any from the list of: new content from a specific user being uploaded; new content available on a specific channel; specific content has been viewed; new content is in a system user's Inbox.

Following receipt of a notification signal a system user would be notified by a change in an application on their remotely located terminal, e.g. an icon might glow, change shape, colour etc. In order to ascertain further information about the changes occurring on the server the user may interact with the icon (e.g. by hovering their cursor over it) in order to gain further information about the change. This interaction may cause a user request to be sent to the input means of the server which can in turn output further information to the icon (e.g. by means of a signal instructing a pop up window or banner on the system user's computer). In this manner a system user may be able to determine what information has changed on the server without having to either log in to the server or open a local application programme.

According to a second aspect of the present invention there is provided a video content storage system for storing and distributing video content to system users comprising a content server according to the first aspect of the invention; a communications network and one or more remotely located user terminals, each of which are in communication with the content server over the network.

### BRIEF DESCRIPTION OF THE FIGURES

The present invention is described further in the attached figures in which:

FIG. 1 shows an overview of the system architecture for the present invention;

FIG. 2 shows a screenshot of the graphical user interface on a system user's computer for interacting with the present invention;

FIGS. 3 to 14 are flow charts showing general modes of operation of the present invention;

FIG. 15 shows the use of such a network by a bank to send financial news to a subscriber group;

FIG. 16 is an example of a desktop widget that may be used in conjunction with an embodiment of the present invention.

It is noted that the present invention is also referred to herein as “Winkball”. The term “Wink” is used interchangeably with “video message” or “video file”.

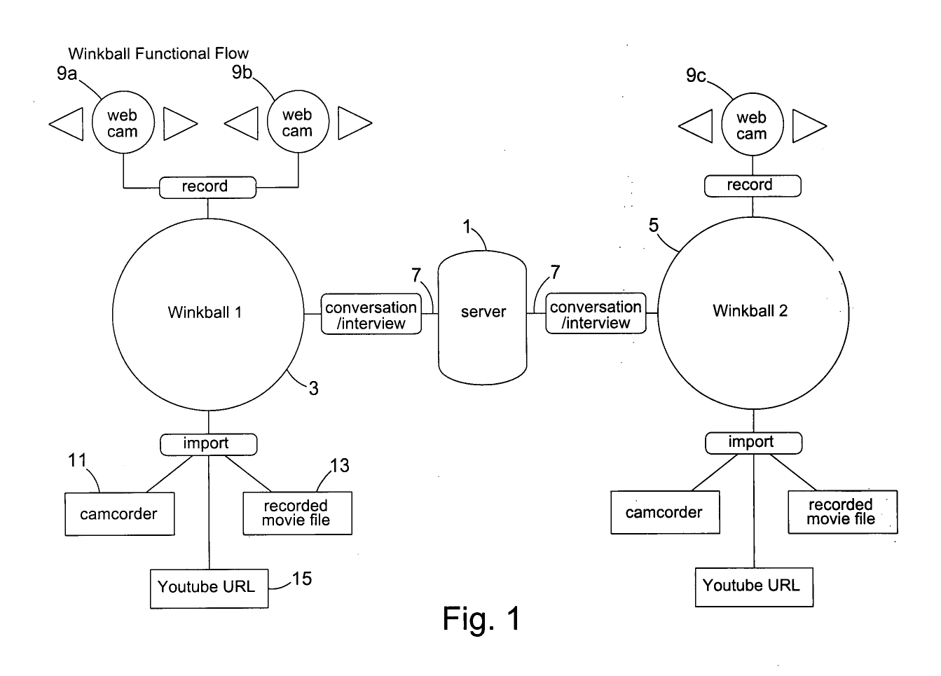

FIG. 1 shows the general system architecture of the present invention. A server 1 in accordance with embodiments of the present invention is accessible by system users having an application program/client (Winkballs 3 and 5) installed on their computers. Each application program is in communication with the server via a communications network 7. Each application program (3, 5) is in communication with one or more webcams (9a, 9b, 9c) associated with the system user's remote terminal which allow video content to be recorded and uploaded to the server 1. Video content may also be uploaded from other sources (e.g. camcorder 11, video file 13 or external video such as YouTube 15) to the server 1.

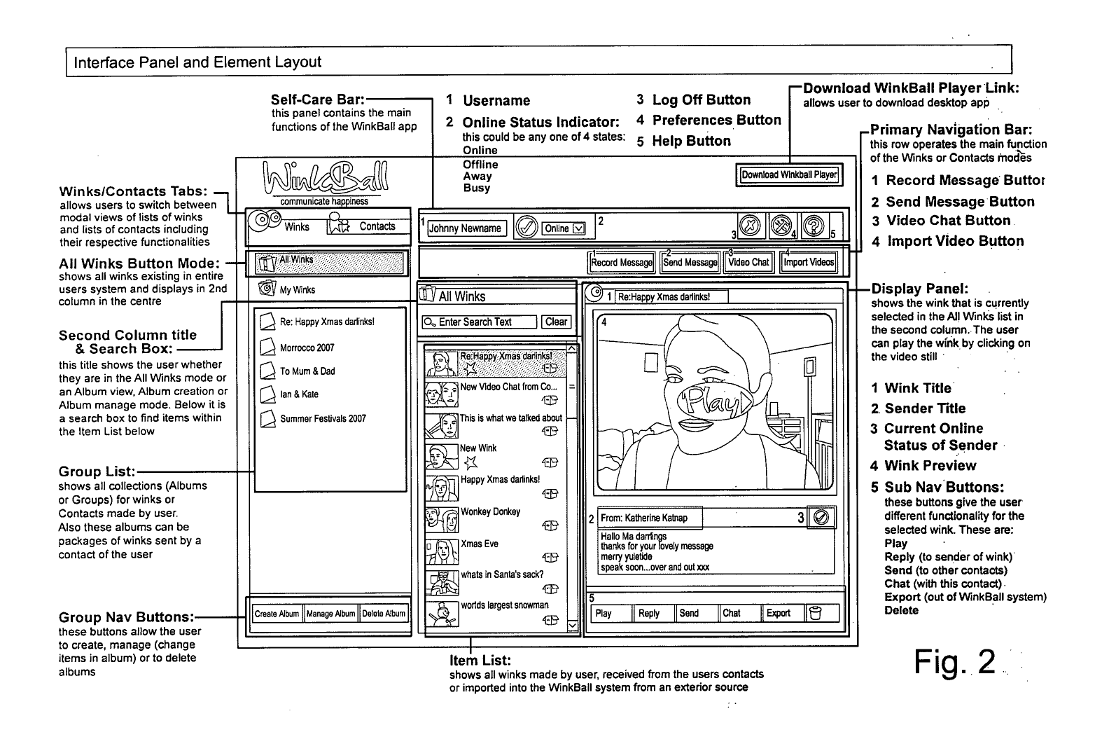

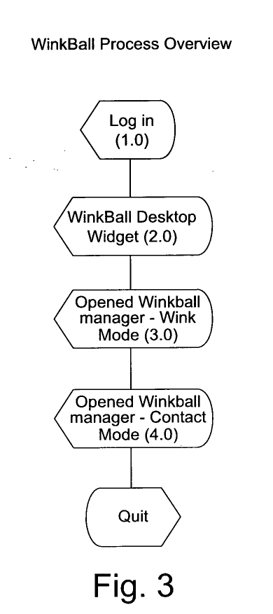

The graphical user interface associated with the software client (3, 5) is shown in FIG. 2. FIGS. 3 to 14 are flow charts showing the general modes of operation of the present invention.

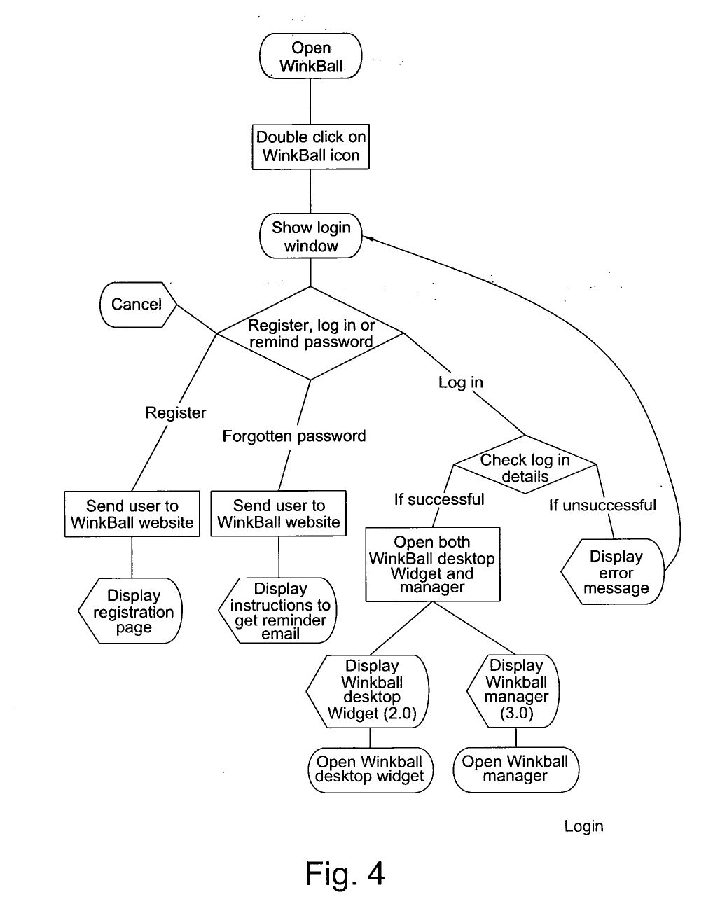

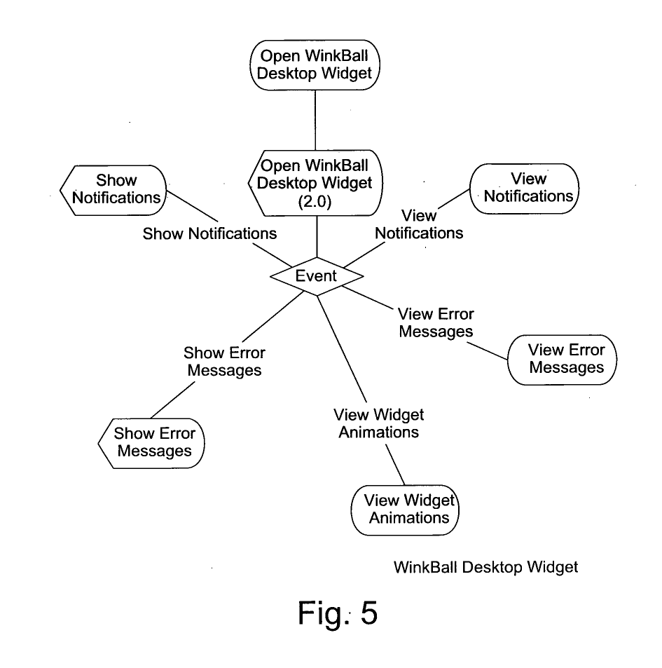

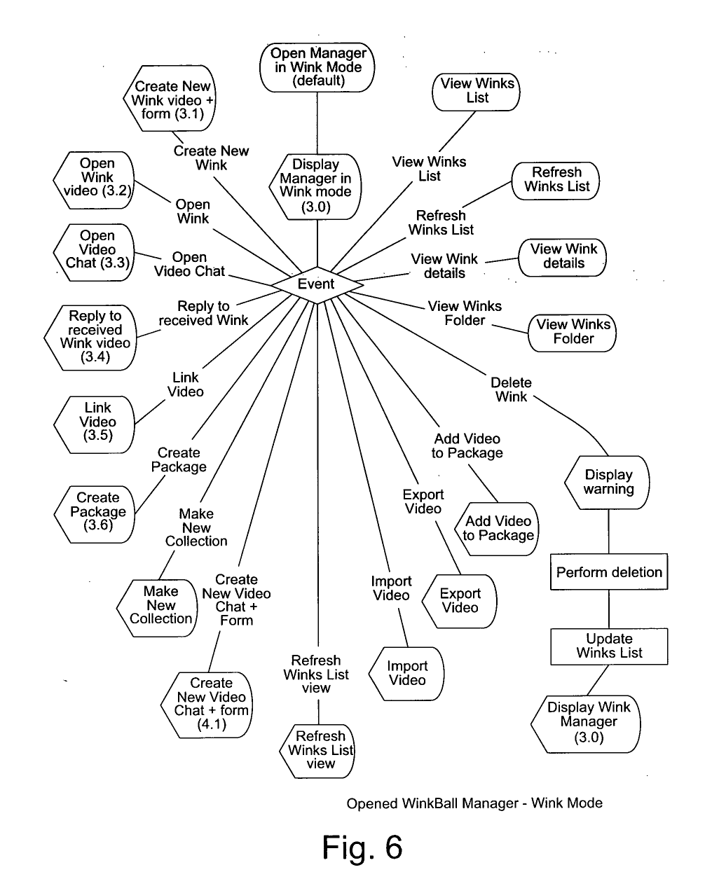

FIG. 3 shows the overall process of logging in and opening the application client (3,5). FIG. 4 shows the log in process in greater detail. The application client (3, 5) may comprise a desktop widget that sits on a system user's computer that is in communication with the server 1. FIG. 5 shows how, following an event (such as a new video content being uploaded), a number of different actions may occur (e.g. the user may view a notification sent by the server or the user may be shown an animation). When the application client (3, 5) is open on the system user's computer then a greater number of actions may be taken following an event and these are shown in FIG. 6.

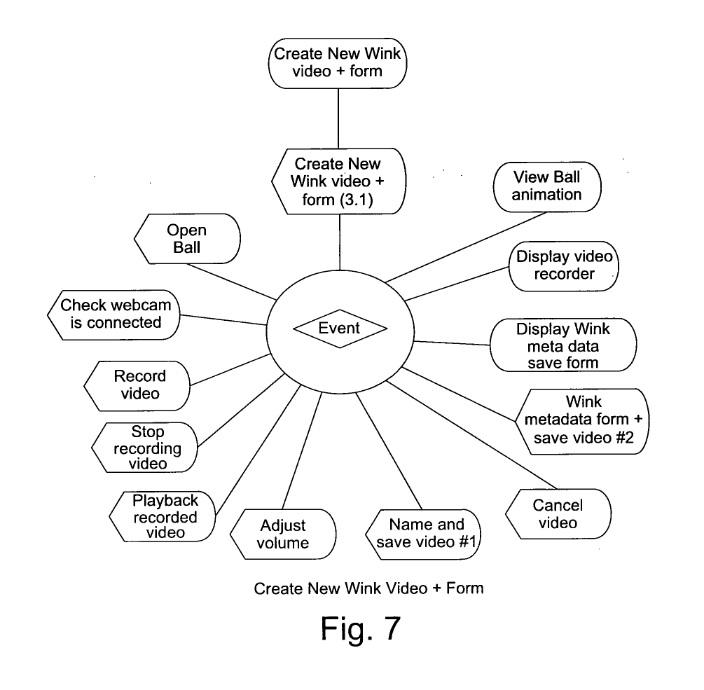

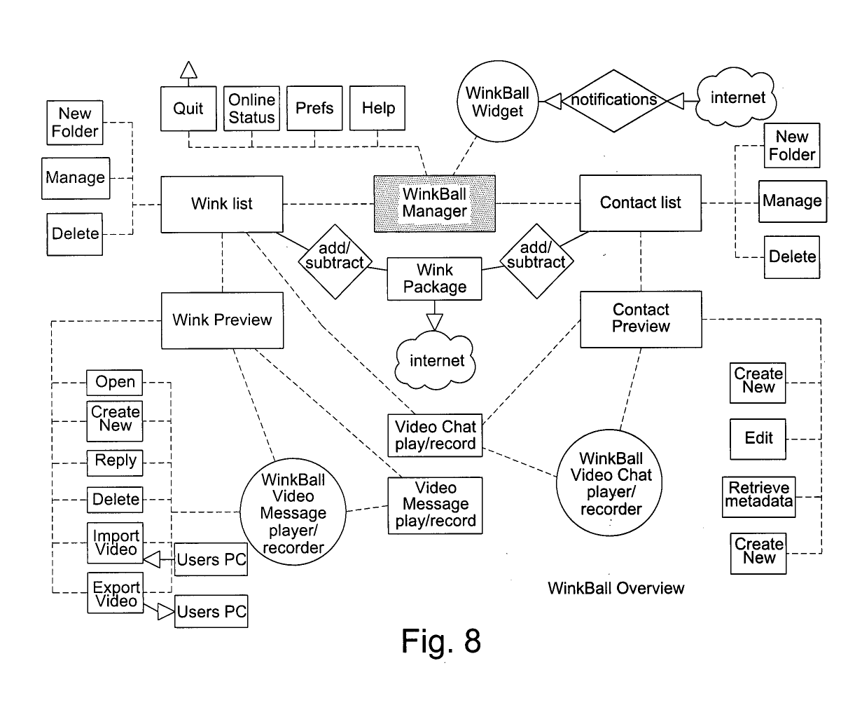

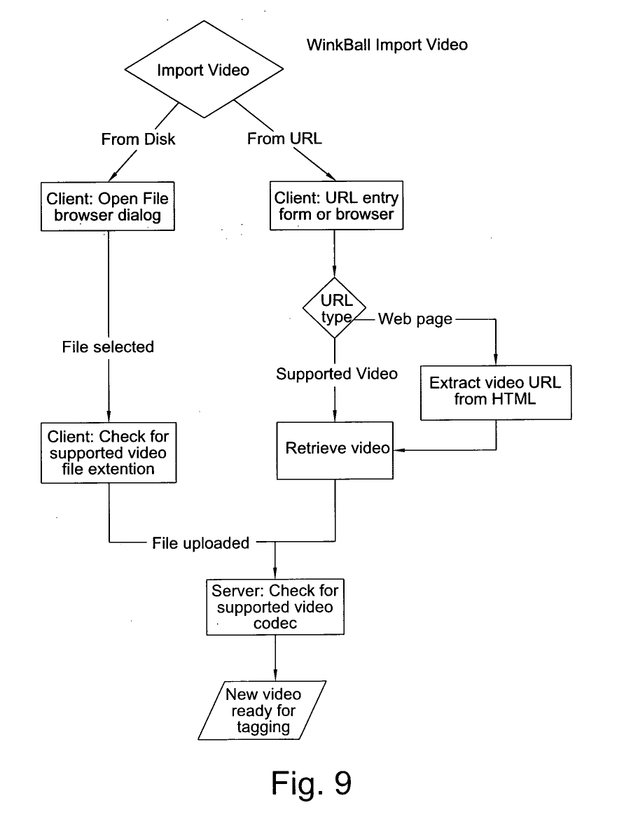

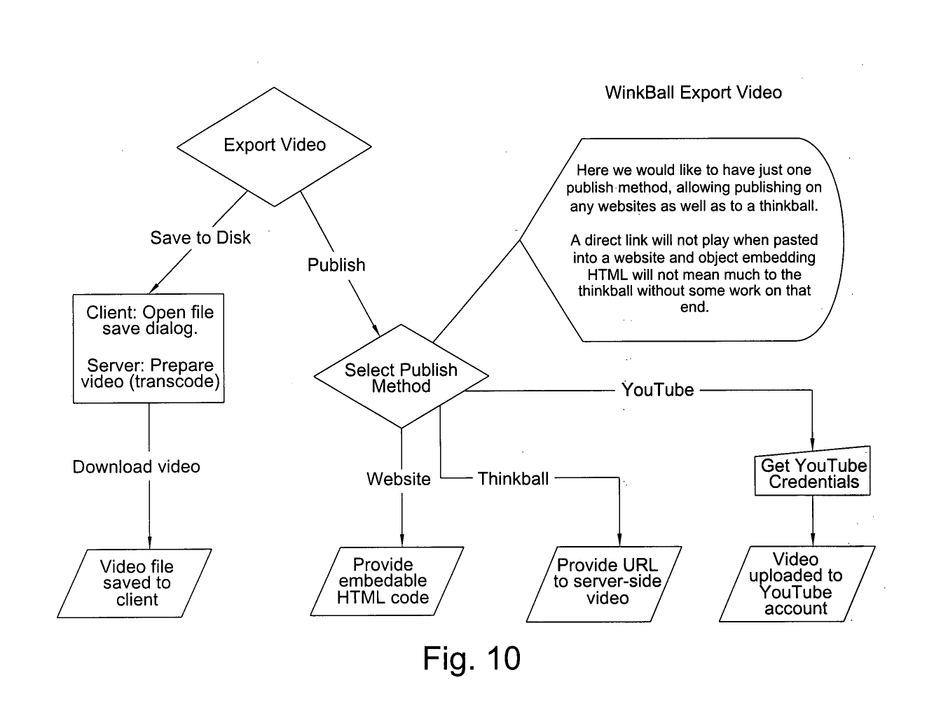

FIG. 7 shows the process of creating new video content to upload to the server/send to another user. FIG. 8 is a representation of all the various actions available to a user who is interacting with the graphical user interface of FIG. 2. FIGS. 9 and 10 show the processes of uploading and exporting video content to/from the server 1.

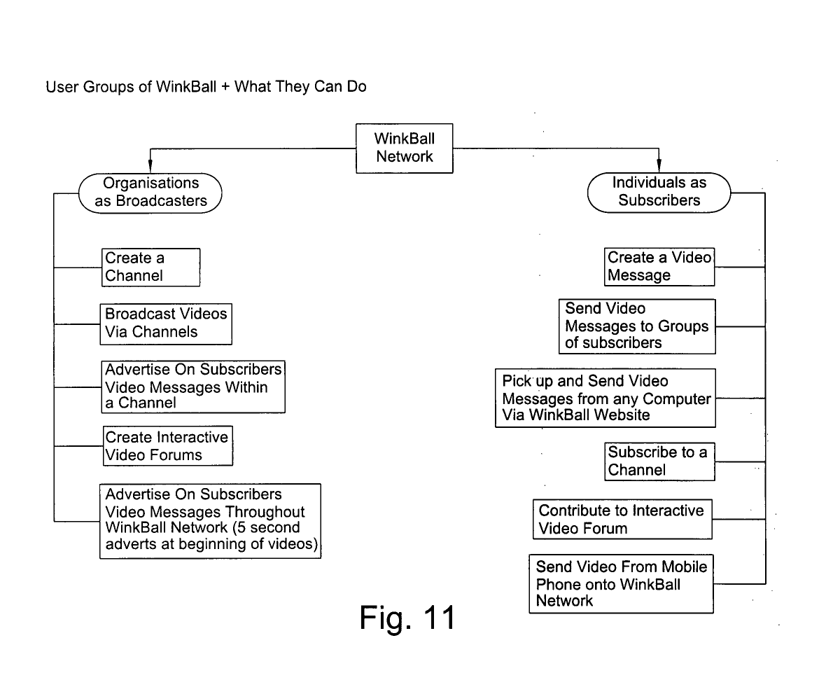

Within the communications network users may be classed as individual subscribers or broadcasting organisations. FIG. 11 shows the various actions that each class of user can perform.

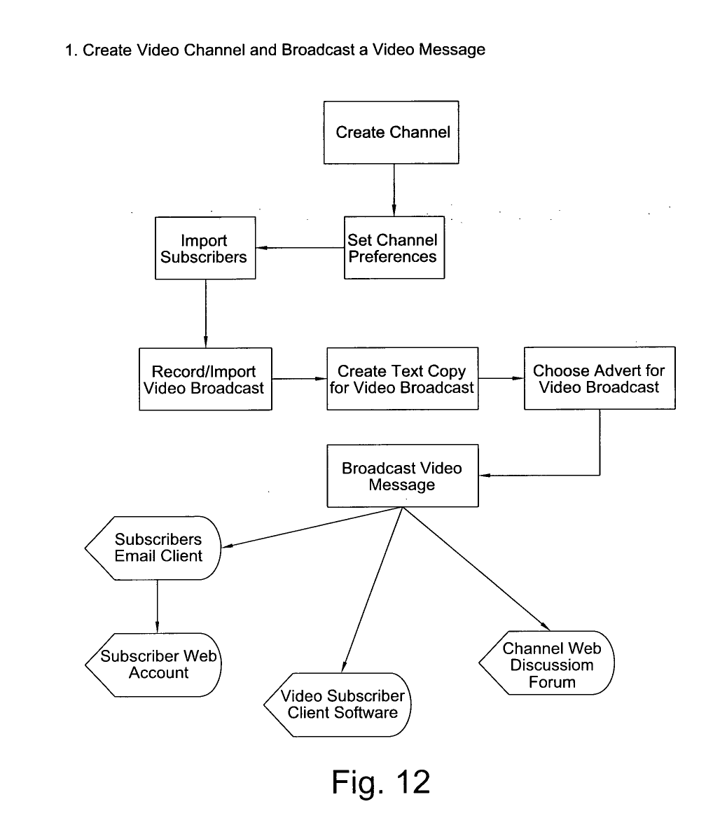

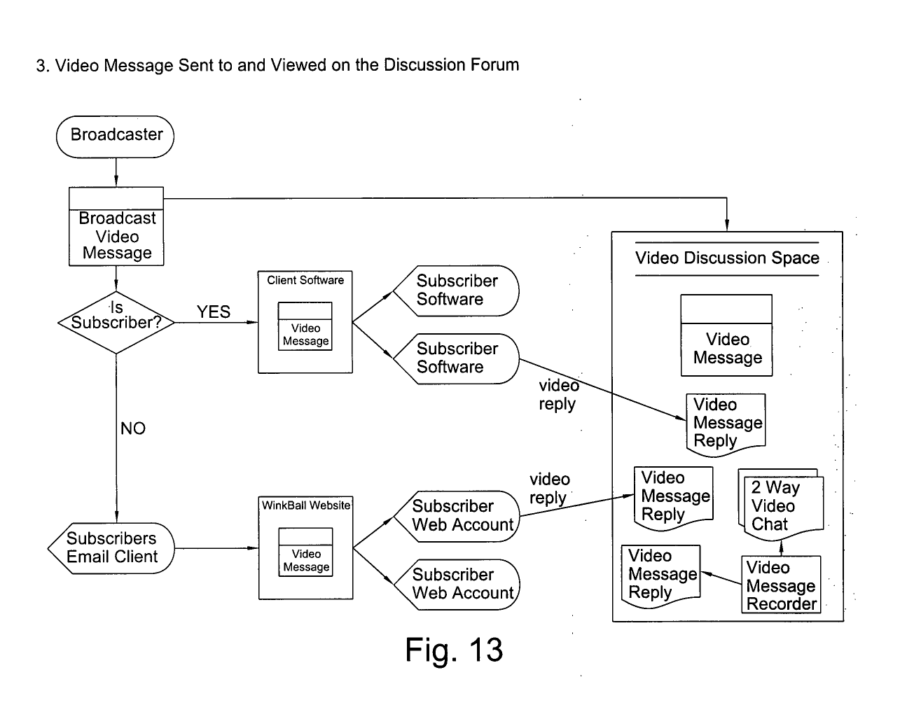

FIGS. 12 and 13 illustrate how a broadcast channel may be set up within the system of the present invention. In FIG. 12 the process of setting up a broadcast channel is shown and it can be seen that the resultant content may be distributed in a number of ways (e.g. to users who have subscribed to that channel or to a video discussion forum). In FIG. 13 a broadcaster outputs a video message via the communications network of the present invention. If a particular user is a subscriber then the message is delivered automatically to that user. User who are not subscribers may still be able to access the same video content via the broadcasters website. Video replies to the initial message may then be attached to a video discussion space. The initial message appears towards the top of this video discussion space and takes up relatively more room than the replies which are arranged beneath it.

Further details of the features of the figures referenced above are described below.

### Winks

Winks are video files recorded using the WinkBall software client (3, 5) and a webcam (9a-c) attached to the users' computer. These files are played back using a specialized player or via a webpage. Videos can also be imported from outside the application and will be played through the WinkBall interface. These videos or ‘Winks’ can also be exported to be played through external video players (Windows Media Player, Realtime Player, etc). Video recorded within the WinkBall client can be either one way or two way, depending on whether the user intends to send a video message or whether they intend to engage in a video conversation (or chat session) with one of their contacts.

### Contacts

Within the system architecture of the present invention, a system user's network of contacts is of a closed nature, giving the users the privacy of operating within a private network which is free from spam, unwanted advertising and unsolicited contact from unknown sources. Within the network users can only receive content from other users that they have specified they wish to receive videos from the sender. This process ensures the network is safe for all ages of user and that advertising can be targeted to particular market segments.

### Video Message

Users can record a video message that they wish to send to one of their contacts or they can play a video message that they have saved or have been sent by one of their contacts.

### Video Chat

Video chat is initiated by a user sending a ‘nudge’ (or notification) to one of their specified contacts. This ‘nudge’ will take the form of a visual notification panel appearing on the Self-help bar at the top of the interface (see FIG. 2). The sender of this ‘nudge’ will know whether the person they wish to converse with has their WinkBall open, as their online status will be set to ‘online’ in the contacts preview. Once the recipient has received the ‘nudge’, they can choose to engage in a video chat with their contact.

### Wink Package

The saved video files (known as Winks) can be sent to and received from pre-established contacts. One or more video file can be attached to a ‘Wink Package’ which can then be sent to any of the users' contacts. These video files will be received by the recipient when they next open their WinkBall application and will immediately be sent to the ‘Incoming’ folder in the ‘Winks list’. The recipients will be informed of the new video that has arrived in their WinkBall by way of a notification from the WinkBall desktop widget. A title and text message can also be sent with this ‘Wink Package’ to give context to the communication.

### WinkBall Interface

The interface (see FIG. 2) comprises a desktop widget (with the downloaded version—see also FIG. 5), a manager panel (see also FIG. 6) containing the ‘Winks’ and ‘Contacts’ directories (the previews of both of these areas) as well as the video players and recorders (again, with the downloaded version) for ‘Winks’ and Video Chat sessions.

The general look and feel of the interface is one of fun and accessibility, a simple and non-threatening presentation that allows even the most uninitiated computer user to feel comfortable using this application. Therefore the use of soft and friendly graphics and animations are an important part of the design.

As this is an online desktop application, the manager panel is housed within a operating-system-defined window. In its default state the application doesn't take up the entire screen (unless specified by the user) but sits in a minimised state on the users' desktop. In this way it's approach is similar to ThinkBall (see WO2008/071992).

The desktop widget may take any suitable form that gives notifications when needed, such as when another user is attempting to make contact through Video Chat, or to notify the user of recent video additions to the WinkBall.

The manager panel is the centre of the functional organisation structure of WinkBall. The organisational structure is based around two main directory lists—the videos (winks) and the contacts and the user can toggle between these two views (see Winks/Contact tabs in FIG. 2). These directory lists comprise of two levels; Group list Folder level and Item list File level—the video files have to be inside a folder, but the user can create their own folders and copy the video files across to them so that they can develop their own organizational structure. Initially however, the Winks list will comprise of two folders—‘All Winks’ and ‘My Winks’ folders; ‘My winks’ will be all the videos and video chats that are recorded by the user and ‘All Winks’ are all the videos and video chats that are sent to the user by other users, as well as their own. Although a video chat file would sit in the ‘My Winks’ folder of both users involved in that video chat session. These two folders are universal in the Wink List and cannot be moved or deleted. Whenever a user creates a new album folder, they can add a video file to it from the ‘My Winks’ and the ‘All Winks’ folders. That video file will now sit in the new folder but will also still be listed in the ‘My Winks’ and the ‘All Winks’ folders. Next to each name of video or contact in the item lists (in the second column), is a package icon which allows the user to add the video or contact to a Wink Package [see ‘Wink Package’ above].

The user can add to the video item list in a number of ways; by recording a video message or video chat (with another user) or by receiving a video message from another user.

To the right of the item list is the display area where content selected in the Item list (videos or contacts) is previewed. In the online web app version, the video player/recorder and video chat player/recorder is activated from here. The video player plays back from the display area in the third column, but when the user is recording a video message or having a chat with a contact, the display area expands to the left to take over the space of the item list in the second column.

The video meta-data may include a title, an author name for the file, a date and time and a text message, as well as an indication of the video author or collaborators' online status. From here the video can be opened, replied to (if it is a sent video), a new video created or linked to, or the video file being previewed can be sent to a package [see ‘Wink Package’ above].

The preview of a contact includes an image (or avatar), a title or name, an email address and maybe a description, as well as an indication of that contacts online status. The main functions of this contact preview include creating a new contact, editing an existing contact, initiating a video chat or retrieving a contacts details automatically via their email address.

Because the Winks and Contacts lists operate on the two levels of Folder and File, the preview area provides two different levels of preview—the group folder view includes a list of all files within that folder and a minimised preview of each file, whereas the file view provides the user with a preview of just the one file or contact that is selected in the item list.

When the user wishes to collect video items to package together and send to specified contacts the wink package display is activated by the user clicking on the package icon on the right of the video item in the item list, or by clicking the ‘Send’ button on the video display under the preview of the video, or by clicking the ‘Send Message’ button in the Primary Navigation bar. However with this last option the user will be activating a blank Wink Package, whereas the first two options will directly place the video in question into a wink package.

The structure of the wink package looks very similar to any email client—a ‘subject area’ to type in a title, a ‘recipients area’ to add contacts from the contacts list, a ‘winks to send’ area that is added to from the winks list, a ‘message area’ to type a message to the recipient(s) and finally ‘send’ and ‘cancel’ buttons.

Above the item list and display area, at the top, is the Self-help bar which holds the users identity name as it is displayed to other users (their network username), a drop-down online status selector, Preferences and Help buttons and the Quit button.

Just below the Self-help bar is the Primary Navigation bar that, for the Winks mode will hold the buttons; ‘Record Message’, ‘Send Message’, ‘Video Chat’, ‘Import Video’. In the contacts mode, the buttons are; ‘Notifications’, ‘Add Contacts’, ‘Import Contacts’.

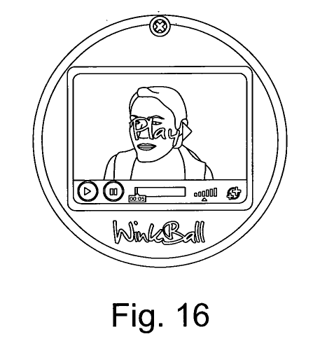

With the downloaded desktop version of the application, the video player/recorder and video chat player/recorder may both housed within an animated ball (see FIG. 16), which opens by zooming in from a point in an engaging way to reveal the video player/recorder sitting in a stylized circle.

For the video chat player/recorder a double ball may open, the video area in the left hand ball would always be the user and the video area on the right hand side would be their contact that they are chatting with, so obviously it would be the opposite way round for both users when they record the video chat session, as well as when they play back the recorded session.

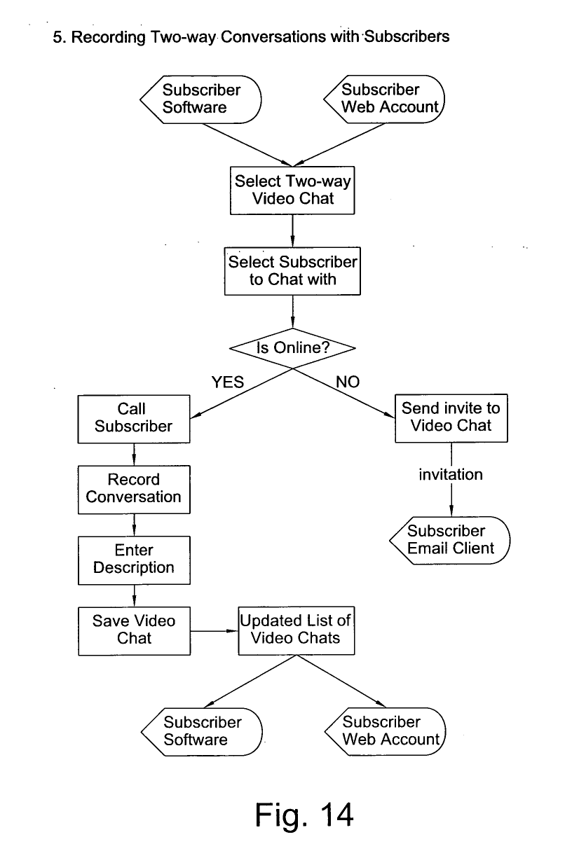

### Two Way Video Conferencing (See Also FIG. 14)

One of the features of the present invention is the ability for two users to record a real time video conference on the central server. Once recorded the conversation is available as a “Wink” to the two users.

Once saved, a two way conference can be replayed at any time. The present invention ensures that the two video streams are synchronised and presented together whenever the video is accessed.

### Applications of the Present Invention

The present invention may be applied to a number of different uses. For example, the system may be installed on the Intranet of a company to allow company employees in different locations to interact via video message.

The system may also be used in a video broadcast network in which a broadcaster (e.g. TV company, charity, actor, sportsperson etc) broadcasts video messages to a subscriber group.

Subscribers may sign up to a particular broadcaster, receive video messages and may even leave video based reply messages to the broadcaster's message via a video forum.

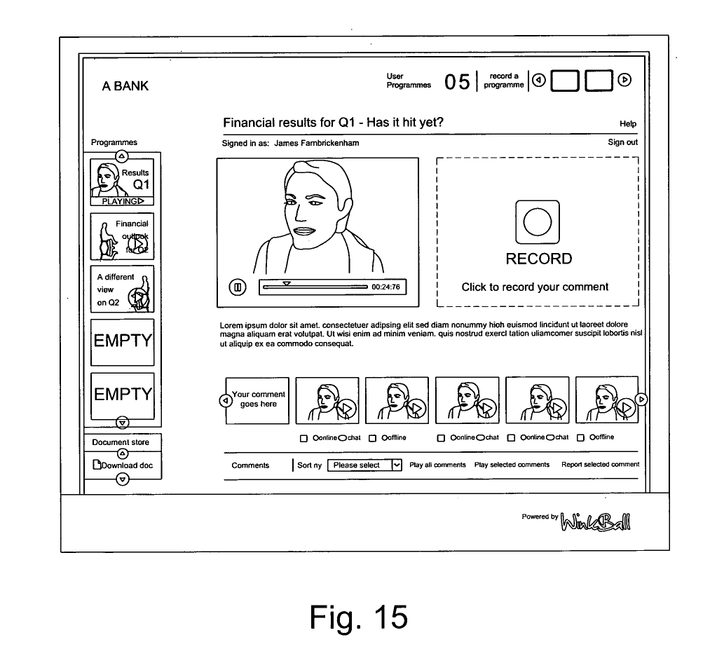

The broadcaster application of the present is described in more detail below and with reference to FIGS. 12 and 13 which show the system architecture and operational flow charts for a broadcast network and also with reference to FIG. 15 which shows the use of such a network by a bank to send financial news to a subscriber group.

There are two distinct user groups that use WinkBall in the context of a video broadcast network—Broadcasters and Subscribers.

Broadcasters are organizations that can:
1. Create multiple channels that allow them to broadcast video messages to WinkBall subscribers anywhere in the world.
2. Create video online discussion forums where subscribers can leave video messages and have recorded video conversations with other subscribers to that channel.

3. Prepend 5 second adverts to video messages sent across the WinkBall Network.
4. Record two-way conversations with subscribers.
5. Import external videos and broadcast to subscribers of a channel.
6. Record live interviews with “WinkBall Video Stick” and stream to discussion forum.

Subscribers are individuals that can:
1. Send video messages to each other and post them on external websites, forums and blogs.
2. Record two-way conversations with other subscribers and post them on external websites, forums and blogs.
3. Subscribe to channels of video broadcasts made available by organisation broadcasters.
4. Send videos from mobile phones to subscribers.
5. Import external videos and share with other subscribers.

The various types of network applications for a video broadcast network include:
1. Free individual and group video messaging for subscribers.
2. Record video chats with friends and family.
3. Targeted video prepended adverts designed exclusively for use on the WinkBall Network.
4. Push video broadcasting.
5. Record two-way interviews.
6. Send corporate video messages to targeted groups of subscribers.
7. Conduct video-based market research and ascertain responses from video forum discussions.
8. Broadcast news/sports to targeted groups.
9. Record web-based video conversations anywhere in the world.
10. Target advertising to selected groups of subscribers.
11. Record live interviews with WinkBall Video Stick. Useful for:

| | |
|---|---|
| Journalists | Market Research companies |
| Police | Social Services |
| TV Companies | Vox Pop |

The video broadcast network application may generate revenue in a number of ways, namely:
1. Broadcasters pay to create channels and to send video messages to existing clients/large groups of subscribers.
2. Broadcasters pay for WinkBall to create 5 second adverts to be used exclusively across the WinkBall Network.
3. Broadcasters pay to prepend video messages sent across WinkBall Network with 5 second adverts.
4. Broadcasters pay for customised video campaigns using video forums, targeted video messaging and customised client applications.
5. Subscribers pay to not have prepended 5 second adverts on videos.

It will be understood that the embodiments described above are given by way of example only and are not intended to limit the invention. It will also be understood that the embodiments described may be used individually or in combination.

1. A content server for use in a video content storage system for storing and distributing video content to system users, the server comprising:
input module for communicating, across a communications network, with a system user at a remotely located terminal;
a data store for storing video content; and
output module for streaming stored video content across the communications network to a system user upon receipt of a request to viewed the stored content.

2. A server as claimed in claim 1, wherein the content server is part of a distributed communications network that is accessible by a plurality of user computers wherein the input module is arranged to receive video content related data from system users, for storage in the data store.

3.-4. (canceled)

5. A server as claimed in claim 1, wherein the input module is arranged to receive instructions from system users to amend video content currently stored in the data store.

6. A server as claimed in claim 1, wherein video content stored in the data store comprises a video content file and associated meta data, the meta data stored in the data store being arranged to allow video content to be grouped by a content category.

7. (canceled)

8. A server as claimed in claim 1, wherein the output module is arranged to stream a video content signal to system users to allow video content to be displayed on a graphical user interface of the user's user terminal.

9. A server as claimed in claim 1, further comprising a messaging module arranged to allow users to send video messages, wherein the messaging module is arranged to insert meta data into outgoing messages, outgoing messages having a sender address field and the messaging module being arranged to insert meta data into the address field of each outgoing message.

10. (canceled)

11. A server as claimed in claim 1, wherein video content may be placed on a white list such that only authorized system users can access the video content.

12. A server as claimed in claim 1, wherein the server is arranged to embed stored video content as part of a video blog and wherein the server is arranged to allow system users to post video content in reply to posts on the video blog.

13. (canceled)

14. A server as claimed in claim 1, wherein the server is arranged to group video content by author or by subject matter and wherein the server is arranged to broadcast video content to one or more system users.

15.-16. (canceled)

17. A server as claimed in claim 1, wherein the data store comprises a plurality of additional content files such that each time a system user requests access to video content stored in the data store an additional content file is either prepended or appended to the streamed video content.

18. A server as claimed in claim 1, wherein two or more system users can, via the input module, record video content to the server as part of a video conference, the received video content from each user being stored in a single video content file on the server.

19. A server as claimed in claim 1, wherein the server is arranged to output a notification signal to one or more system users following changes to video content stored in the data store.

20. A server as claimed in claim 19, wherein content is classified by content category and following changes to video content associated with a particular content category, the server is arranged to output a notification signal to system users who are associated with the particular content category.

21. A server as claimed in claim 20, wherein the notification signal is a push communication and wherein the notification signal is sent to a notification icon on the remotely located terminal of a system user, the signal comprising instructions to control the behavior of the icon.

22. (canceled)

23. A server as claimed in claim 21, wherein the instructions sent to the notification icon are dependent on events occurring at the server.

24. A server as claimed in claim 23, wherein the server is arranged to send different types of behavior instructions to the notification icon depending on the events occurring at the server, each type of behavior instruction causing the notification icon to behave in a different manner such that the icon may be controlled by the server to exhibit multiple behaviors.

25. A server as claimed in claim 21, wherein the server is configurable by a system user to personalize the notification signals and associated behavior instructions that are sent out by the server.

26. A server as claimed in claim 23, wherein the events occurring on the server comprise any from the list of: new content from a specific user being uploaded; new content available on a specific channel; specific content has been viewed; new content is in Inbox.

27. A server as claimed in claim 21, wherein the input module is arranged to receive a user request from the notified system user for additional information relating to changes on the server.

28. A video content storage system for storing and distributing video content to system users comprising a content server as claimed in claim 1; a communications network and one or more remotely located user terminals, each of which are in communication with the content server over the network.
